(19) United States
(12) Patent Application Publication
(10) Pub. No.: US 2026/0292406 A1
(43) Pub. Date: Sep. 24, 2026

(54) SURROUND FOR A LOUDSPEAKER

(71) Applicant: GSS-AUDIO GRAWE-SEEBAUER-SCHNEIDER GDBR, Kiefersfelden (DE)

(72) Inventor: Christian SEEBAUER, Nittenau (DE)

(73) Assignee: GSS-AUDIO GRAWE-SEEBAUER-SCHNEIDER GDBR, Kiefersfelden (DE)

(21) Appl. No.: 19/474,266

(22) PCT Filed: Apr. 15, 2024
(86) PCT No.: PCT/EP2024/060158

§ 371 Date: Oct. 10, 2025

(30) Foreign Application Priority Data
Apr. 20, 2023 (DE) 10 2023 109 979.5

(51) Int. Cl. H04R 7/20; H04R 7/04

(52) U.S. Cl. CPC H04R 7/20; H04R 7/04

(57) ABSTRACT

The invention relates to a surround for a loudspeaker, preferably a planar loudspeaker, comprising an attachment region extending in an attachment surface and an elongated, preferably rectangular or oval, vibrating region arranged within the attachment region, wherein a contour of the vibrating region is configured such that the vibrating region extends, in sections, on different sides of the attachment surface.

The invention relates to a surround for a loudspeaker, preferably a planar loudspeaker.

From DE 10 2018 124 261 A1 a planar loudspeaker is known which comprises a planar sound panel and a drive unit for driving the sound panel. The drive unit comprises a plate-shaped coil carrier with a coil formed thereon and a magnet assembly. The coil carrier is arranged in a gap between two magnet units of the magnet assembly. A surround (retaining element) can be omitted or may be provided only in sections.

In funnel-shaped and/or cone-shaped loudspeakers, circular surrounds are used which have a uniform contour with a U-shaped cross-section.

A disadvantage thereof is that the maximum excursion is small. A conventional surround having a semicircular cross-section would, at large excursion, buckle due to the geometry, and the effective radiating area would strongly depend on the diaphragm position, which would lead to very large nonlinear distortions. A buckling surround is, for example, particularly problematic in the case of elongated diaphragms with small radii at the narrow side.

For reproduction of low tones, a loudspeaker must exhibit a high volume displacement, where the volume displacement is calculated as the product of effective radiating area and excursion. This product must be as large as possible. Accordingly, either a configuration with a large diaphragm area and small excursion or a configuration with a small diaphragm area and large excursion is possible.

The configuration with a large diaphragm and small excursion on the large front surface of a flat loudspeaker may appear simpler; however, due to other physical constraints, the same performance as with lateral diaphragms cannot be achieved.

Due to the flat housing, the volume inside the loudspeaker is very small, and very powerful drives are required in order to produce the volume displacement. However, the force with which the drives move the diaphragm also acts in the opposite direction on the housing, which, due to its flatness, is not particularly bending-stiff in this direction.

As tests have shown, it is indeed possible to produce the volume displacement on a flat housing with a large diaphragm, but then the housing vibrates so strongly that the loudspeaker cannot be used in this manner. The forces can be cancelled only by two consecutive, oppositely moving diaphragms, wherein the drives can in a certain manner be nested next to one another, but the installation depth nevertheless becomes too large for acceptable volume displacements.

In the configuration with a narrow diaphragm mounted at the side of the loudspeaker, the loudspeaker housing is loaded along the stiff side by the drives, and a symmetrical, force-cancelling configuration with oppositely moving, consecutive diaphragms is possible without the installation depth changing. The challenge here, however, is to achieve the large diaphragm excursion required due to the small radiating area.

For low-distortion reproduction it is required that the surround can cover the necessary excursion range without mechanical buckling and without the radiating area changing significantly over the displacement range. The effective radiating area is defined as the quotient of volume displacement and the diaphragm amplitude.

A change in this radiating area over the displacement position of the diaphragm leads to nonlinear distortions. If the diaphragm is moved at a constant speed from the minimum position to the maximum position, then, with an ideal surround and diaphragm, the displacement of the volume per unit time is constant.

Mathematically, the effective radiating area can be considered as a surface integral over the change in position over the diaphragm area and the surround area in the direction of the normal vector of the respective surface segment per change in position of the diaphragm area. The shape and the direction of movement of the partial areas are irrelevant here, since the normal vector is a function of the surface.

Conventional surrounds cannot be used with narrow installation widths. For example, in planar loudspeakers in which the diaphragms are arranged at the lateral, narrow end faces, the installation widths are extremely small. A large excursion is therefore required here.

It is therefore an object of the invention to provide a surround for a loudspeaker, a system with a surround and a diaphragm, and a loudspeaker, in which a high maximum excursion is achieved.

This object is achieved by the subject matter of the independent claims.

According to the invention, the surround is suitable for use in a loudspeaker.

The loudspeaker may preferably be a planar loudspeaker, i.e., a flat loudspeaker.

Preferably, the surround comprises a rubber material or consists thereof. The rubber material may, for example, be a relatively hard and/or vulcanized rubber. This withstands the high internal pressure in the housing and therefore does not buckle or bend unintentionally.

The surround has an attachment region extending in an attachment surface, preferably an attachment plane.

The attachment surface is preferably planar. Alternatively, it may also be curved and/or arched.

By way of example, the surround is fastened at the attachment region, preferably directly, to the loudspeaker, e.g., to a speaker basket.

The attachment region preferably includes an outer rim or outer edge of the surround.

Preferably, the surround completely surrounds a drive of the loudspeaker.

Within the attachment region, an elongated, preferably rectangular or oval, vibrating region is arranged.

The term “rectangular” is to be understood broadly. Thus, shapes which are substantially rectangular but, for example, have rounded corners are also encompassed.

Preferably, the vibrating region is formed as a frame, ring or edge region of an opening or diaphragm. Thus, the surround may, for example, have an opening and/or a diaphragm in its interior.

By way of example, the surround as a whole may have an elongated, preferably rectangular or oval, outer contour and/or an elongated, preferably rectangular or oval, outer periphery. The outer contour and/or the outer periphery is preferably located in the attachment surface.

The vibrating region can be set into vibration by the drive, for example in a plane of vibration oriented perpendicularly to the attachment surface. The plane of vibration may, for example, run parallel to a direction of movement of the vibrating region.

Preferably, the contour is non-uniform.

The contour of the vibrating region is configured such that the vibrating region extends, in sections, on different sides of the attachment surface, preferably of the attachment plane.

The contour of the vibrating region may extend perpendicularly to the attachment surface and/or parallel to the plane of vibration.

The cross-section of the vibrating region preferably extends-partly or entirely-above and—partly or entirely—below the attachment surface. Thus, for example, the contour may project upward beyond the attachment surface in one section and project downward below the attachment surface in another section.

The vibrating region thus extends, in sections, in effect on different sides of a longitudinal cross-sectional surface of the surround, preferably a central longitudinal cross-sectional surface.

The special shape of the surround enables an extremely high maximum excursion with a narrow installation width and with minimal changes in the effective radiating area.

The surround is preferably constructed such that, at large excursion, the bulges can bend and/or unfold in a controlled manner, with the effective radiating area remaining nearly constant over the excursion.

The shape or contour of the surround can preferably be calculated and/or (numerically) optimized by means of a computer simulation.

The surround according to the invention enables an extremely high maximum excursion with narrow installation width and low distortion and/or with minimal changes in the effective radiating area, which currently represents the only possibility for a narrow loudspeaker for the low-frequency range. For bass, a large volume displacement is required, which is achieved by the large excursion.

The surround is highly resistant to the high internal pressure of the housing and, due to its shape or contour, does not buckle.

Further embodiments of the invention are apparent from the dependent claims, the description and the drawings.

According to one embodiment, the contour is axially symmetric.

So that the surround cannot pull the diaphragm to one side or twist the diaphragm, the surround is preferably constructed with twofold symmetry, which, due to the symmetry, provides a net force of 0 newtons and a torsional moment of 0 newton-meters independently of the diaphragm position.

The surround may, for example, consist of four segments arranged symmetrically about two axes through the center. Each individual segment may, for example, consist of three larger sinus-like support lines which run approximately parallel to the rim of the surround. The support lines may have approximately a period of one quarter or one sixth of the circumference of the surround.

Preferably, the two long sides of the surround are constructed identically. For example, each long side may have at least or exactly one elevation and at least one valley, preferably exactly two valleys.

Alternatively or additionally, the two short end sides of the surround may also be constructed identically. For example, each long side may have at least or exactly one elevation.

The basic form of the contour is preferably wave-shaped. The elevations and valleys may themselves, in turn, be serrated and/or undulating. The contour is thereby preferably non-uniform.

Additional, smaller sinus-like waves with a significantly higher frequency can thus be located on the support lines. These elements serve to stiffen the peaks of the surround and further increase the maximum possible excursion range.

Due to the shape or contour of the surround, the surround exerts, at every location at which it is in contact with the diaphragm, a different force on the diaphragm.

According to a further embodiment, the contour has, at least in sections, a V-shaped and/or W-shaped cross-section, preferably perpendicular to the attachment surface.

Preferably, V-shaped and W-shaped sections can alternate. By way of example, the contour is thereby non-uniform.

According to a further embodiment, the contour in the region of the short end sides of the surround is wider than in the region of the long sides of the surround.

Preferably, the width of the contour is non-uniform.

The widening of the end sides leads, for example, to advantageous bending behavior with a large maximum displacement range.

According to a further embodiment, the short end sides of the surround are rounded and/or formed semicircularly.

According to a further embodiment, the surround has a central opening.

The opening may, for example, be elongated, preferably rectangular or oval.

The surround itself can thus be formed as a frame, ring or edge region of an opening.

According to a further embodiment, the surround has a fastening device for a diaphragm.

The fastening device may, for example, have an inner rim or be formed as an inner rim. The diaphragm can be fastened to the inner rim, for example by means of a fastening agent, e.g., an adhesive, for example by bonding.

The diaphragm preferably comprises a rigid material, for example a metal material such as aluminum, a plastic material such as polypropylene, and/or a fiber-reinforced composite, for example carbon, or consists thereof.

It is also conceivable to dispense with the diaphragm and to form the loudspeaker instead only with a surround. The maximum possible excursion per loudspeaker width can thereby be further increased.

The invention further relates to a system with a surround according to the invention and a diaphragm arranged within the surround.

The surround may preferably have a fastening device, e.g., an inner rim, for the diaphragm. The diaphragm can be fastened to the inner rim, for example by means of a fastening agent, e.g., an adhesive, for example bonded.

The diaphragm preferably comprises a rigid material, for example a metal material such as aluminum, a plastic material such as polypropylene, and/or a fiber-reinforced composite, for example carbon, or consists thereof.

Finally, the invention relates to a loudspeaker, preferably a planar loudspeaker, with at least one surround according to the invention and/or a system according to the invention.

The loudspeaker may have at least one speaker basket. Preferably, multiple speaker baskets are provided.

The speaker basket, the surround and/or the diaphragm may preferably be arranged on a lateral, narrow end side of the loudspeaker. Preferably, multiple speaker baskets, surrounds and/or diaphragms are provided. These may preferably be arranged on different sides of the loudspeaker.

By way of example, the surround is or will be fastened at the attachment region, preferably directly, to the loudspeaker, e.g., the speaker basket.

The loudspeaker preferably has a drive. The drive, which is preferably arranged in the speaker basket, comprises at least one magnet and at least one coil.

The magnet may, in sections, have, for example, a different magnetization or polarity. Alternatively, at least two magnets with different magnetization or polarity may be provided.

The coil is preferably flat. For example, the coil may have a width between 1 mm and 10 mm, e.g., 4 mm.

The coil may preferably have at least one winding, the winding extending around a coil core.

A side of the winding opposite the coil core may, for example, have an attachment region for attachment to the loudspeaker. Preferably, the coil is attached to the loudspeaker exclusively via this attachment region.

The winding can thus be attached directly to the loudspeaker, e.g., to the diaphragm and/or to a centering device or a support of the centering device, for example bonded.

A coil carrier is preferably not provided.

The winding may, for example, be formed as a strip and/or have a rectangular cross-sectional area.

For example, the winding comprises an aluminum material and/or a copper material or consists thereof.

Preferably, the winding further comprises an insulation layer, preferably an anodized layer and/or an adhesive enamel layer.

Preferably, the winding consists of an anodized aluminum strip. The anodized layer may have, for example, a thickness between 1 μm and 10 μm, e.g., 4 μm. The anodized layer electrically insulates superimposed windings from one another.

The coil core may, for example, comprise air and/or a plastic material, preferably fiber-reinforced, or consist thereof.

In the case of a coil core of air, in effect no solid coil core is provided. In this case, for example, a strong bonding material may be helpful to ensure that the coil remains in the desired shape.

Preferably, the surround completely surrounds the drive of the loudspeaker.

All aspects, embodiments and features of the invention described herein can, preferably also independently of the specific configuration in connection with which they are mentioned, be combined with one another. Preferably, all features of the dependent claims can be combined with one another and with any feature of the independent claims.

The invention is described below by way of example with reference to the drawings. In the drawings:

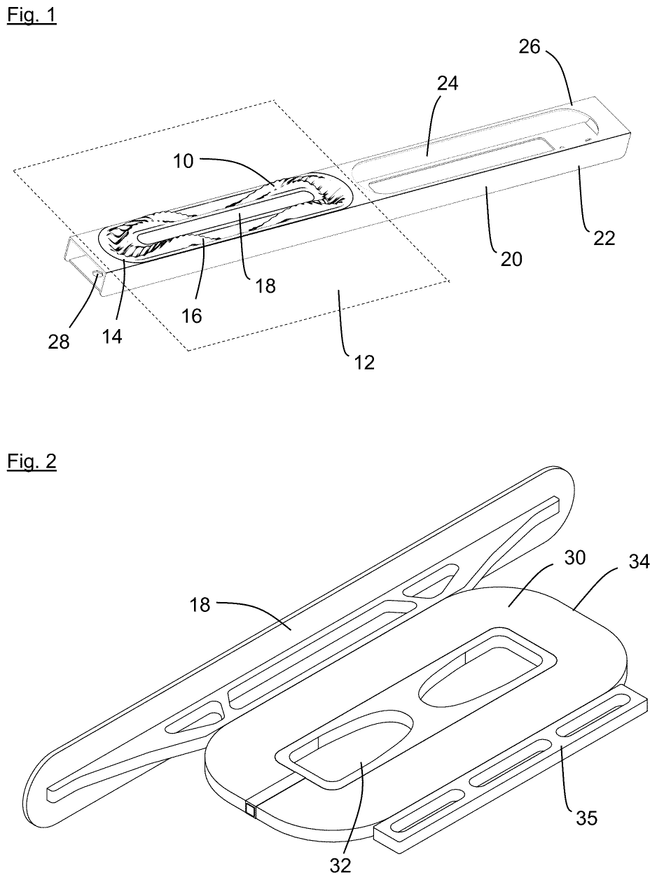

FIG. 1 shows a perspective view of an embodiment of a system according to the invention with a surround, a diaphragm and a speaker basket,

FIG. 2 shows a perspective view of a coil with a diaphragm fastened thereto,

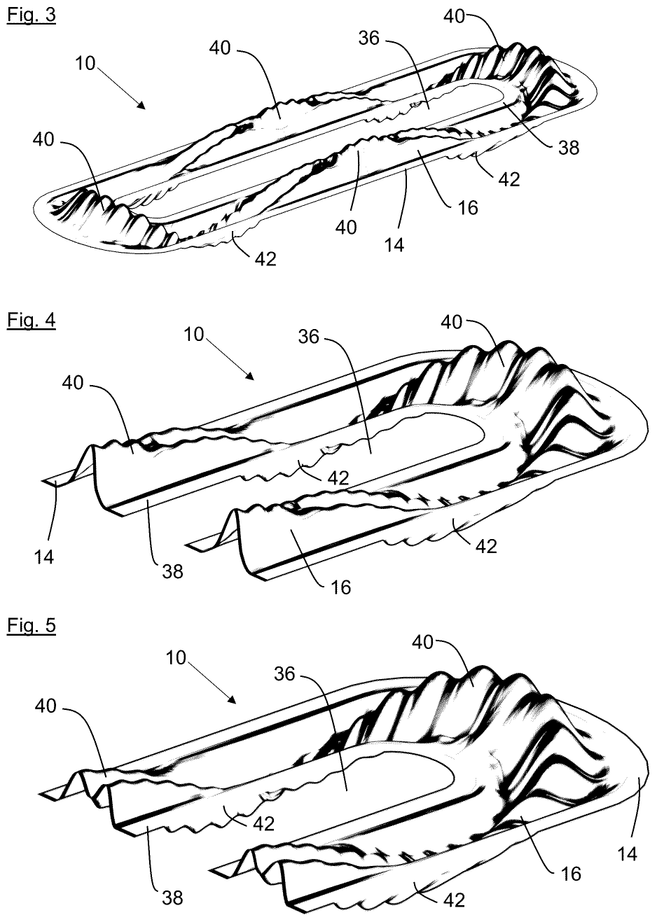

FIG. 3 shows a perspective view of an embodiment of a surround according to the invention,

FIG. 4 shows a sectional view of the surround of FIG. 3, and

FIG. 5 shows a further sectional view of the surround of FIG. 3.

It is first to be noted that the embodiments shown are purely exemplary in nature. Thus, individual features may be realized not only in the combination shown, but also individually or in other technically meaningful combinations. For example, the features of one embodiment can be combined in any way with features of another embodiment. Preferably, the number of openings, mounting openings and/or surrounds in the speaker basket is arbitrary.

If a figure contains a reference sign that is not explained in the immediately associated description text, reference is made to the corresponding preceding or subsequent explanations in the figure description. Identical or comparable components are designated by the same reference signs in the figures and are not explained again.

FIG. 1 shows a surround (10) for a loudspeaker, preferably a planar loudspeaker, having an attachment region (14) extending in an attachment surface (12) shown in dashed lines.

The attachment region (14) corresponds, in effect, to an outer rim of the surround (10).

Within the attachment region (14), an elongated vibrating region (16) is arranged.

The surround (10) has a central opening (36) in which a diaphragm (18) is arranged.

The surround (10) is fastened to a speaker basket (20). The speaker basket (20) has an angled base body (22) and two, preferably identical, openings (24) for loudspeaker drives. For better visibility, no loudspeaker drive is shown in the right-hand opening (24).

The speaker basket (20) has a mounting section (26) for direct fastening of a surround (10).

The mounting section (26) corresponds, in effect, to a rim of the opening (24).

The surround (10) is fastened via the attachment region (14) directly to the mounting section (26) of the speaker basket (20), for example by bonding.

For fastening of the speaker basket (20) to a loudspeaker housing, the speaker basket (20) can have mounting openings (28). The mounting openings (28) can, for example, be formed as hexagonal apertures.

The mounting openings (28) can serve, for example, for riveting in rivet nuts, with which fastening to the loudspeaker housing is then effected using screws.

As shown in FIG. 2, a coil (30) with a coil core (32) and multiple windings (34) (the individual windings are not shown for clarity) can be fastened directly to the diaphragm (18), for example bonded. Furthermore, the coil (30) can be fastened to a support (35) of a centering device, for example bonded.

In FIGS. 3 to 5 it is shown that the surround (10) has a central opening (36).

Furthermore, the surround (10) has a fastening device (38) for the diaphragm (18).

The fastening device (38) corresponds, in effect, to an inner rim of the surround (10), which extends around the central opening (36).

The diaphragm (18) can be fastened directly to the fastening device (38), for example bonded.

The contour of the vibrating region (16) is configured such that the vibrating region (16) extends, in sections, on different sides of the attachment surface (12).

The vibrating region can have multiple elevations (40) and valleys (42).

The basic form of the contour is preferably wave-shaped. The elevations (40) and valleys (42) may themselves, in turn, be serrated and/or undulating. The contour is thereby preferably non-uniform.

In the region of the short end sides, the contour of the surround (10) is wider than in the region of the long sides of the surround (10).

As can be seen in the sectional views in FIGS. 4 and 5, the cross-section of the contour is at least in sections V-shaped or W-shaped.

### Reference Signs

10 surround
12 attachment surface
14 attachment region
16 vibrating region
18 diaphragm
20 speaker basket
22 base body
24 opening
26 mounting section
28 mounting opening
30 coil
32 coil core
34 winding
35 support
36 central opening
38 fastening device
40 elevation
42 valley

1. A surround (10) for a loudspeaker, preferably a planar loudspeaker, comprising:
an attachment region (14) extending in an attachment surface (12), preferably an attachment plane; and
an elongated vibrating region (16), preferably rectangular or oval, arranged within the attachment region (14),
wherein a contour of the vibrating region (16) is configured such that the vibrating region (16) extends, in sections, on different sides of the attachment surface (12).

2. The surround (10) of claim 1, wherein the contour is axially symmetric.

3. The surround (10) of claim 1 or 2, wherein the contour has, at least in sections, a V-shaped and/or W-shaped cross-section.

4. The surround (10) of any one of claims 1 to 3, wherein the contour in a region of short end sides of the surround (10) is wider than in a region of long sides of the surround (10).

5. The surround (10) of any one of claims 1 to 4, wherein the short end sides of the surround (10) are rounded and/or formed semicircularly.

6. The surround (10) of any one of claims 1 to 5, wherein the surround (10) has a central opening (36).

7. The surround (10) of any one of claims 1 to 6, wherein the surround (10) has a fastening device (38) for a diaphragm (18).

8. A system comprising a surround (10) according to any one of claims 1 to 7 and a diaphragm (18) arranged within the surround (10).

9. A loudspeaker, preferably a planar loudspeaker, comprising at least one surround (10) according to any one of claims 1 to 7 and/or a system according to claim 8.
